(19) United States
(12) Patent Application Publication
(10) Pub. No.: US 2018/0087789 A1
(43) Pub. Date: Mar. 29, 2018

(54) Portable Bathroom Ventilation System

(71) Applicant: Maykel Nunez, Cape Coral, FL (US)

(72) Inventor: Maykel Nunez, Cape Coral, FL (US)

(21) Appl. No.: 15/276,176

(22) Filed: Sep. 26, 2016

(51) Int. Cl. F24F 7/013; E04H 1/12; F04D 13/06; F21V 33/00; F21V 23/04; F21S 9/03

(52) U.S. Cl. CPC F24F 7/013; E04H 1/1216; F04D 13/06; E03D 9/04; F21V 23/04; F21S 9/032; F21V 33/0096

(57) ABSTRACT

A portable bathroom ventilation system includes a portable bathroom that has an outer wall and a roof. A ventilation unit is coupled to the portable bathroom. The ventilation unit detects a temperature within the portable bathroom. The ventilation unit urges air outwardly from the portable bathroom when the ventilation unit detects the temperature has exceeded a trigger temperature. Thus, the temperature in the portable bathroom is lowered.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to ventilation devices and more particularly pertains to a new ventilation device for selectively ventilating a portable bathroom.

### BRIEF SUMMARY OF THE INVENTION

An embodiment of the disclosure meets the needs presented above by generally comprising a portable bathroom that has an outer wall and a roof. A ventilation unit is coupled to the portable bathroom. The ventilation unit detects a temperature within the portable bathroom. The ventilation unit urges air outwardly from the portable bathroom when the ventilation unit detects the temperature has exceeded a trigger temperature. Thus, the temperature in the portable bathroom is lowered.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a ventilation unit of a portable bathroom ventilation system according to an embodiment of the disclosure.

FIG. 2 is a back perspective view of an embodiment of the disclosure.

FIG. 3 is a cross sectional view taken along line 3-3 of FIG. 2 of an embodiment of the disclosure.

FIG. 4 is a cross sectional view taken along line 4-4 of FIG. 2 of an embodiment of the disclosure.

FIG. 5 is a schematic view of an embodiment of the disclosure.

### DETAILED DESCRIPTION OF THE INVENTION

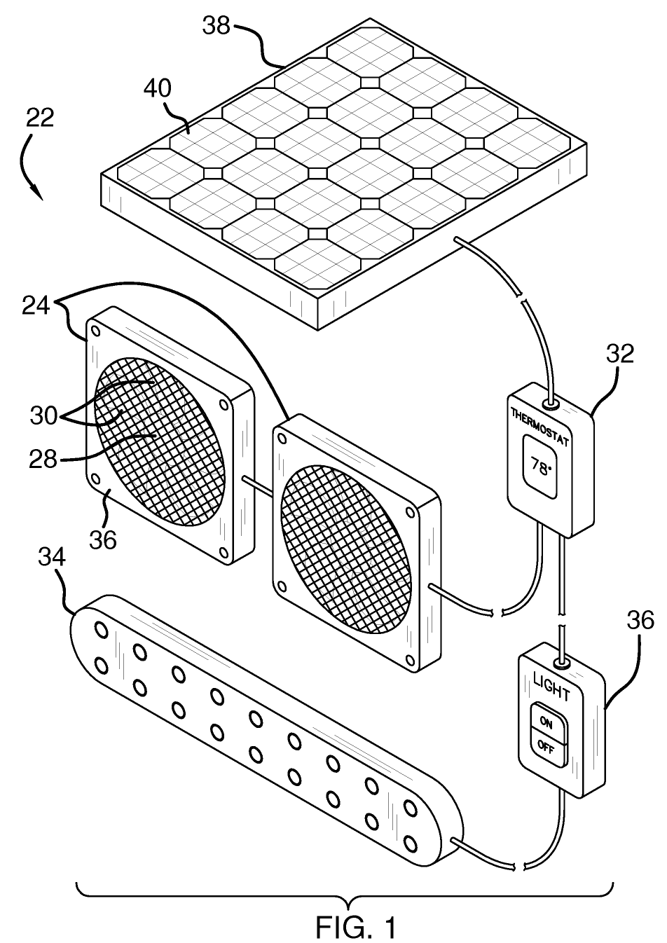

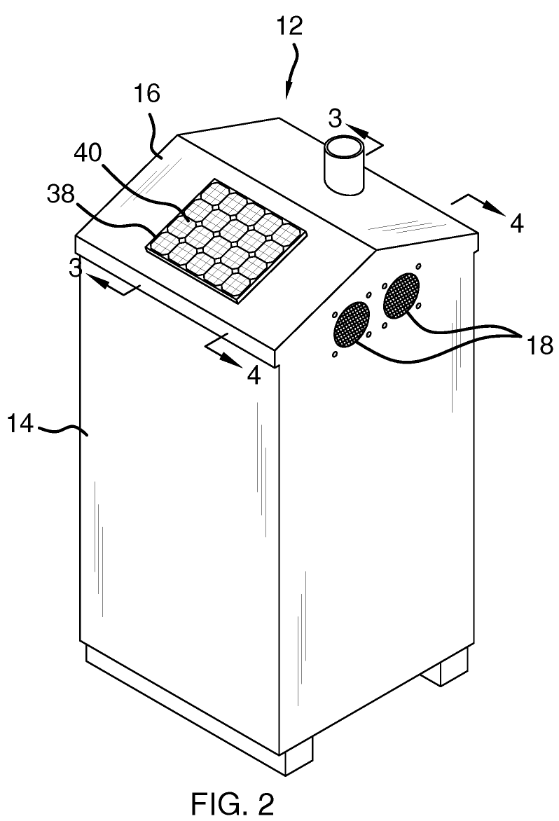

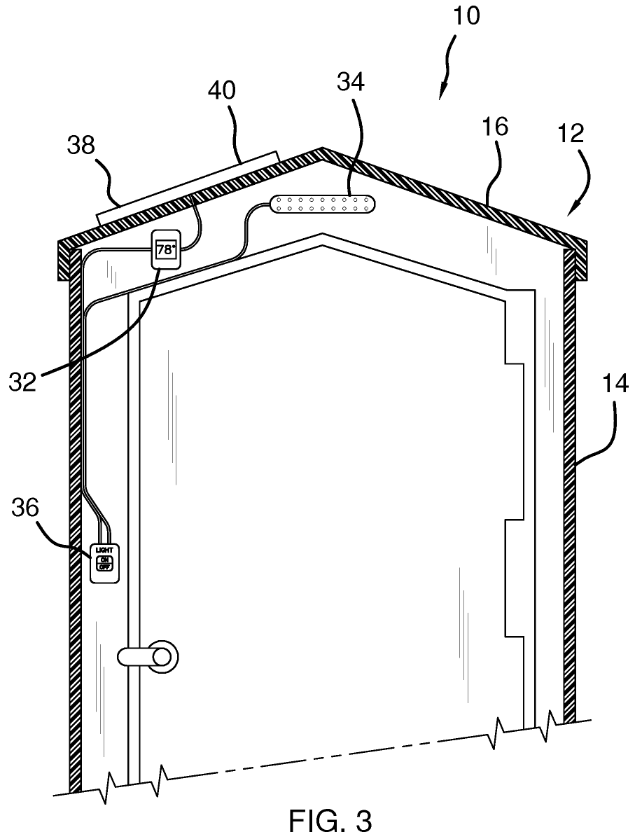

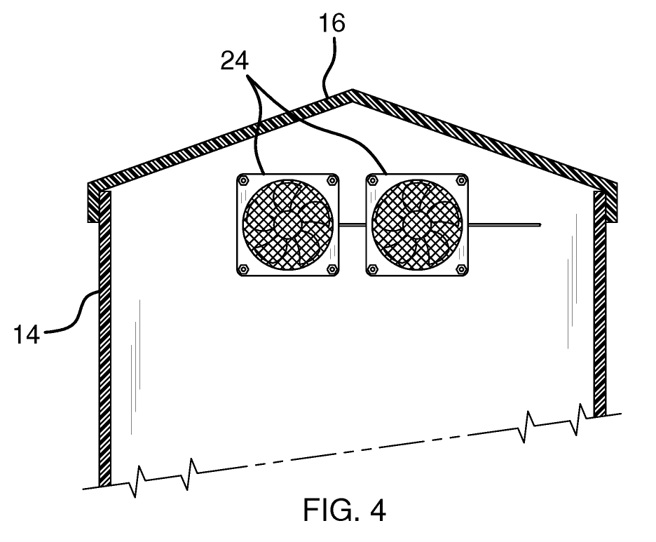

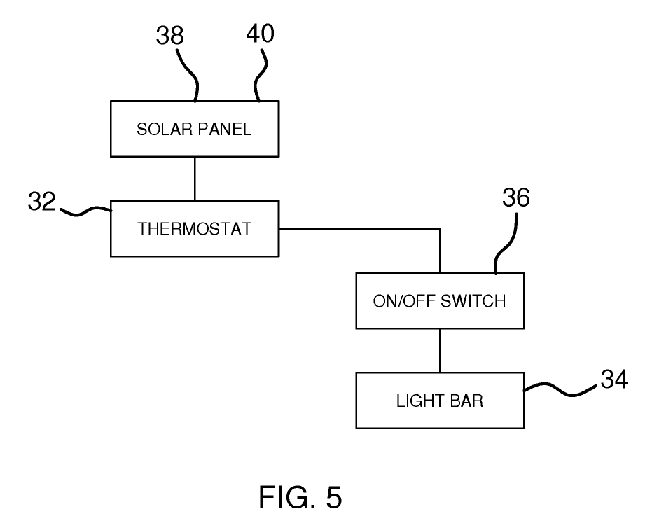

With reference now to the drawings, and in particular to FIGS. 1 through 5 thereof, a new ventilation device embodying the principles and concepts of an embodiment of the disclosure and generally designated by the reference numeral 10 will be described.

As best illustrated in FIGS. 1 through 5, the portable bathroom ventilation system 10 generally comprises a portable bathroom 12. The portable bathroom 12 has an outer wall 14 and a roof 16. The portable bathroom 12 may be a portable bathroom 12 of any conventional design. The outer wall 14 has a pair of fan apertures 18 extending therethrough. The outer wall 14 has a back side 20 and each of the fan apertures 18 may be positioned on the back side 20.

A ventilation unit 22 is provided and the ventilation unit 22 is coupled to the portable bathroom 12. The ventilation unit 22 detects a temperature within the portable bathroom 12. The ventilation unit 22 urges air outwardly from the portable bathroom 12 when the temperature exceeds a trigger temperature. Thus, the temperature in the portable bathroom 12 is lowered thereby enhancing comfort for a user.

The ventilation unit 22 comprises a pair of fans 24 and each of the fans 24 is coupled to the outer wall 14. Each of the fans 24 is aligned with an associated one of the fan apertures 18. Each of the fans 24 comprises a housing 26 that is coupled to the outer wall 14. A motor 28 is positioned within the housing 26. The motor 28 may be an electrical motor 28 or the like.

Each of the fans 24 includes a plurality of blades 30. Each of the blades 30 is coupled to the motor 28. The motor 28 rotates each of the blades 30 when the motor 28 is turned on. Thus, each of the fans 24 urges air outwardly through the fan apertures 18.

A thermostat 32 is provided and the thermostat 32 is coupled to the outer wall 14. The thermostat 32 is positioned within the portable bathroom 12. Thus, the thermostat 32 detects the temperature within the portable bathroom 12. The thermostat 32 may comprise an electronic thermostat 32 or the like.

The thermostat 32 is electrically coupled to each of the fans 24. The thermostat 32 turns each of the fans 24 on when the temperature within the portable bathroom 12 exceeds the trigger temperature. The thermostat 32 turns each of the fans 24 off when the temperature within the portable bathroom 12 falls below the trigger temperature. The trigger temperature may be a temperature ranging between seventy degrees Fahrenheit and eighty degrees Fahrenheit.

A light emitter 34 is provided and the light emitter 34 is coupled to the outer wall 14. The light emitter 34 is positioned within the portable bathroom 12. Thus, the light emitter 34 illuminates an interior of the portable bathroom 12. The light emitter 34 may comprise an LED light bar or the like.

A switch 36 is provided and the switch 36 is coupled to the outer wall 14. The switch 36 is positioned within the portable bathroom 12 and the switch 36 may be manipulated. The switch 36 is electrically coupled to the light emitter 34. Thus, the switch 36 turns the light emitter 34 on and off.

A power supply 38 is coupled to the portable bathroom 12. The power supply 38 is electrically coupled to the switch 36. The power supply 38 comprises a solar panel 40 that is positioned on the roof 16. Thus, the solar panel 40 is exposed to sunlight thereby facilitating the solar panel 40 to convert the sunlight into electrical energy.

In use, the switch 36 is manipulated to turn on the light emitter 34. The thermostat 32 turns the fans 24 on when the temperature in the portable bathroom 12 exceeds the trigger temperature. Thus, air is vented outwardly to cool the interior of the portable bathroom 12. The fans 24 maintain the temperature within the portable bathroom 12 at a comfortable temperature.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A portable bathroom ventilation system comprising:
a portable bathroom having an outer wall and a roof, said outer wall having a pair of fan apertures extending therethrough; and
a ventilation unit being coupled to said portable bathroom, said ventilation unit being configured to detect a temperature within said portable bathroom, said ventilation unit being configured to urge air outwardly from said portable bathroom when said ventilation unit detects the temperature has exceeded a trigger temperature thereby facilitating the temperature in said portable bathroom to be lowered, said ventilation unit including a pair of fans, each of said fans being coupled to said outer wall, each of said fans being aligned with an associated one of said fan apertures; and
a thermostat being coupled to said outer wall, said thermostat being positioned within said portable bathroom wherein said thermostat is configured to detect the temperature within said portable bathroom, said thermostat being electrically coupled to each of said fans such that said thermostat turns each of said fans on when the temperature within said portable bathroom exceeds the trigger temperature, said thermostat turning each of said fans off when the temperature within said portable bathroom falls below the trigger temperature, said thermostat having a screen configured for displaying a temperature within said portable bathroom wherein said thermostat is configured for indicating the temperature within said portable bathroom to an occupant.

2. (canceled)

3. The system according to claim 1, wherein each of said fans comprises:
a housing being coupled to said outer wall;
a motor being positioned within said housing; and
a plurality of blades, each of said blades being coupled to said motor such that said motor rotates each of said blades when said motor is turned on wherein each of said fans is configured to urge air outwardly through said fan apertures.

4. (canceled)

5. The system according to claim 1, further comprising a light emitter being coupled to said outer wall, said light emitter being positioned within said portable bathroom wherein said light emitter is configured to illuminate an interior of said portable bathroom.

6. The system according to claim 1, further comprising:
a light emitter; and
a switch being coupled to said outer wall, said switch being positioned within said portable bathroom wherein said switch is configured to be manipulated, said switch being electrically coupled to each of said fans and said light emitter such that said switch turns each of said fans and said light emitter on and off.

7. The system according to claim 6, further comprising a power supply being coupled to said portable bathroom, said power supply being electrically coupled to said switch, said power supply comprising a solar panel being positioned on said roof wherein said solar panel is configured to be exposed to sunlight thereby facilitating said solar panel to convert the sunlight into electrical energy.

8. A portable bathroom ventilation system comprising:
a portable bathroom having an outer wall and a roof, said outer wall having a pair of fan apertures extending therethrough; and
a ventilation unit being coupled to said portable bathroom, said ventilation unit being configured to detect a temperature within said portable bathroom, said ventilation unit being configured to urge air outwardly from said portable bathroom when said ventilation unit detects the temperature has exceeded a trigger temperature thereby facilitating the temperature in said portable bathroom to be lowered, said ventilation unit comprising:
a pair of fans, each of said fans being coupled to said outer wall, each of said fans being aligned with an associated one of said fan apertures, each of said fans comprising:
a housing being coupled to said outer wall,
a motor being positioned within said housing, and
a plurality of blades, each of said blades being coupled to said motor such that said motor rotates each of said blades when said motor is turned on wherein each of said fans is configured to urge air outwardly through said fan apertures;
a thermostat being coupled to said outer wall, said thermostat being positioned within said portable bathroom wherein said thermostat is configured to detect the temperature within said portable bathroom, said thermostat being electrically coupled to each of said fans such that said thermostat turns each of said fans on when the temperature within said portable bathroom exceeds the trigger temperature, said thermostat turning each of said fans off when the temperature within said portable bathroom falls below the trigger temperature, said thermostat having a screen configured for displaying a temperature within said portable bathroom wherein said thermostat is configured for indicating the temperature within said portable bathroom to an occupant,
a light emitter being coupled to said outer wall, said light emitter being positioned within said portable bathroom wherein said light emitter is configured to illuminate an interior of said portable bathroom,
a switch being coupled to said outer wall, said switch being positioned within said portable bathroom wherein said switch is configured to be manipulated, said switch being electrically coupled to each of said fans and said light emitter such that said switch turns each of said fans and said light emitter on and off,
a power supply being coupled to said portable bathroom, said power supply being electrically coupled to said switch, said power supply comprising a solar panel being positioned on said roof wherein said solar panel is configured to be exposed to sunlight thereby facilitating said solar panel to convert the sunlight into electrical energy.
